(19) United States
(12) Patent Application Publication
(10) Pub. No.: US 2010/0200724 A1
(43) Pub. Date: Aug. 12, 2010

(54) Umbrella Anchor

(76) Inventor: David Kukuk, Mission Viejo, CA (US)

Correspondence Address: MINTZ, LEVIN, COHN, FERRIS, GLOVSKY AND POPEO, P.C, ONE FINANCIAL CENTER, BOSTON, MA, 02111, US

(21) Appl. No.: 12/703,132

(22) Filed: Feb. 9, 2010

Related U.S. Application Data
(60) Provisional application No. 61/152,230, filed on Feb. 12, 2009.

(51) Int. Cl. F16M 13/00

(52) U.S. Cl. 248/530

(57) ABSTRACT

A device is provided configured to be used as an anchor for an umbrella. In one aspect, there is provided a device. The device may include a holder including a hollow interior, a first end configured to receive an umbrella pole, a bottom configured to allow the umbrella pole to rest, and a second end. The device may also include a coupler and a platform. The platform may be configured to support the device (e.g., to prevent the device from tipping, falling, or blowing away when an umbrella is inserted into the device). The platform may be coupled to the holder using the coupler. The platform may include a first receptacle and a second receptacle. The first and second receptacles may be located at distal ends on the bottom of the platform. A first spike may be configured to be detachably inserted into the first receptacle, a second spike may be configured to be detachably inserted into the second receptacle. The first and second spikes may be detached from the first and second receptacles, the platform may be detached from the holder. The first and second spikes and the platform may be configured to be inserted in the first end of the holder, when the umbrella pole has been removed from the holder. The first end of the holder may be configured to accept a cap to secure the first and second spikes and the platform contained within the holder for portability. Related apparatus and methods are also described.

### CROSS REFERENCE TO RELATED APPLICATION

This application claims the benefit under 35 U.S.C. §119(e) of the following provisional application, which is incorporated herein by reference in its entirety: U.S. Ser. No. 61/152,230, entitled “Umbrella Anchor,” filed Feb. 12, 2009 (Attorney Docket No. 39193-501P01US).

### FIELD

The present disclosure generally relates to an umbrella anchor.

### BACKGROUND

With the erosion of the ozone layer, consumers are increasingly concerned with the harmful effects of the sun. To mitigate the harmful rays of the sun, many consumers carry umbrellas to the beach, sporting events, and the like. However, inserting an umbrella directly into the soil or sand is, to say the least, extremely difficult. To address this problem, umbrella anchors are used. An umbrella anchor is a device that anchors the umbrella to, for example, the soil or sand, so that the umbrella stands upright and does not tip, fall, or fly away in the wind.

### SUMMARY

The subject matter disclosed herein provides an umbrella anchor. In one aspect, there is provided a device. The device may include a holder including a hollow interior, a first end configured to receive an umbrella pole, a bottom configured to allow the umbrella pole to rest, and a second end. The device may also include a coupler and a platform. The platform may be configured to support the device (e.g., to prevent the device from tipping, falling, or blowing away when an umbrella is inserted into the device). The platform may be coupled to the holder using the coupler. The bottom of the platform may include a first receptacle and a second receptacle. The first and second receptacles may be located at opposite ends of the platform. A first spike may be configured to be detachably inserted into the first receptacle. A second spike may be configured to be detachably inserted into the second receptacle. The first and second spikes may be detached from the first and second receptacles, and the platform may be detached from the holder, and the platform and spikes may be inserted into the first end of the holder, when the umbrella pole has been removed from the holder. The first end of the holder may be configured to accept a cap to secure the first and second spikes and the platform contained within the holder.

In another aspect, there is provided a device. The device may a holder comprising a hollow interior, a first end configured to receive an umbrella pole and a second end. The coupler may be configured with a spike to form a coupler-spike. The coupler-spike may be detachably inserted into the second end of the holder to provide support for the device. The coupler-spike may be configured to be detachably inserted into the second end of the holder, such that the holder contains the spike portion of the coupler-spike.

It is to be understood that both the foregoing general description and the following detailed description are exemplary and explanatory only and are not restrictive. Further features and/or variations may be provided in addition to those set forth herein. For example, the implementations described herein may be directed to various combinations and subcombinations of the disclosed features and/or combinations and subcombinations of several further features disclosed below in the detailed description.

### BRIEF DESCRIPTION OF THE DRAWINGS

In the drawings,

FIG. 1A depicts an umbrella anchor 100;

FIG. 1B depicts the umbrella anchor 100 with an umbrella 180;

FIG. 2A depicts a holder 105, a coupler 125, and a platform 110;

FIG. 2B depicts a cross section of the holder 105 and the coupler 125;

FIG. 3 depicts a spike 130;

FIG. 4 depicts a holder 105 and a coupler 125;

FIG. 5 depicts another implementation of the umbrella anchor 500;

FIGS. 6A and 6B depict the integrated coupler-spike 530 used in connection with umbrella anchor 500;

FIG. 7 depicts a three spike configuration for the umbrella anchor; and

FIG. 8 depicts an integrated coupler-spike 530 and umbrella pole configuration for the umbrella anchor.

Like labels are used to refer to same or similar items in the drawings.

### DETAILED DESCRIPTION

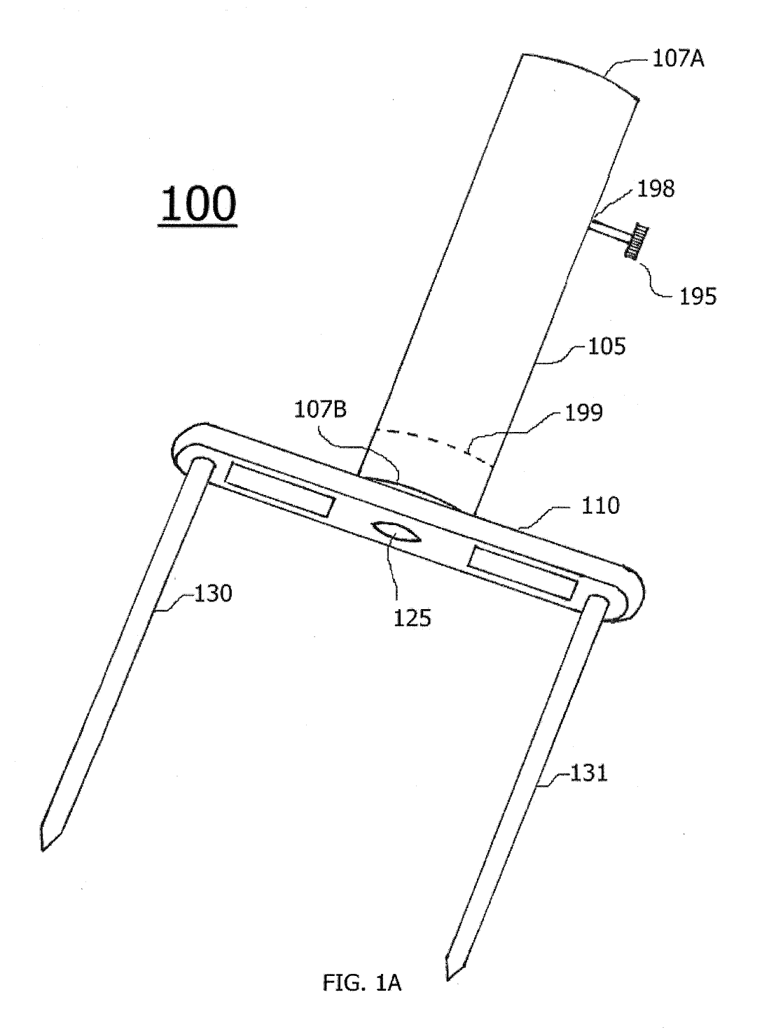

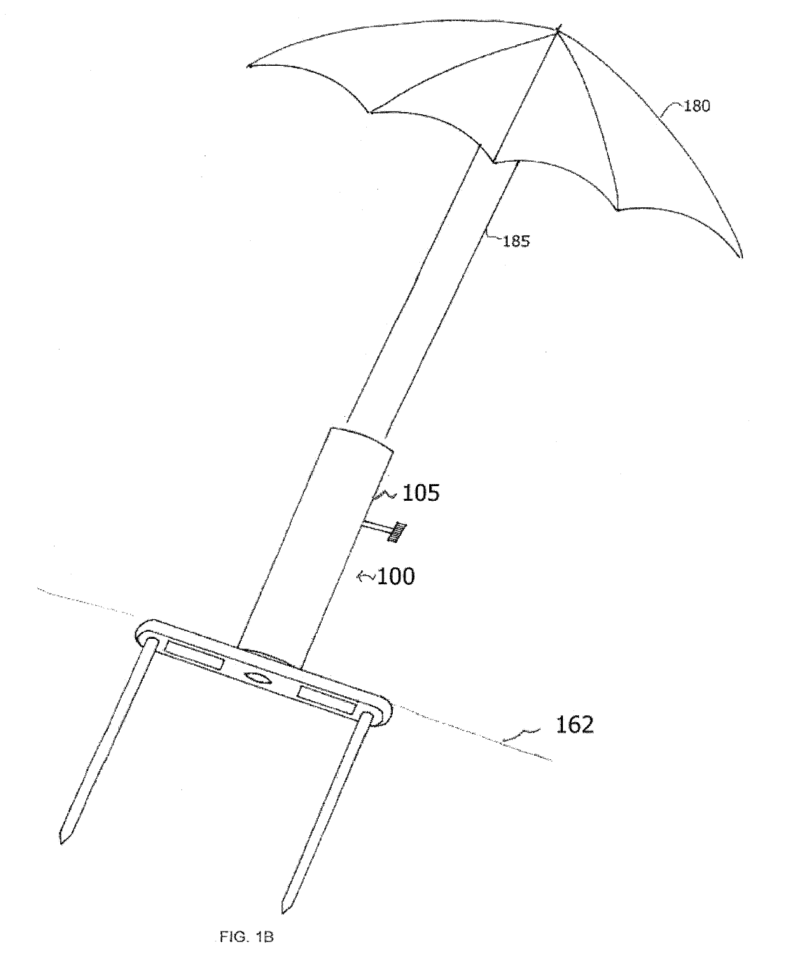

FIG. 1A is a diagram of an umbrella anchor 100. The umbrella anchor 100 includes a holder 105 coupled to a platform 110. The holder 105 may be coupled to the platform 110 using a coupler 125. The umbrella anchor 100 also includes one or more spikes 130 and 131 coupled to the bottom of platform 110. The umbrella anchor 100 may be inserted into the ground, sand, or the like to provide an anchor for an umbrella, so that the umbrella does not fall, tip over, or blow away due to the weight of the umbrella or the force of the wind. Specifically, the spikes 130 and 131 are inserted into the ground, sand, or the like to anchor the umbrella anchor 100, as well as any corresponding umbrella inserted into holder 105.

FIG. 1B depicts an example implementation of umbrella anchor 100 anchored into the soil 162, although the umbrella anchor 100 may be anchored into other media as well. The umbrella 180 includes a pole 185, which is inserted into the holder 105 of umbrella anchor 100.

Referring again to FIG. 1A, the holder 105 may include a set screw 195 that is inserted into a threaded receptacle 198 to secure the umbrella pole 185 to the holder 105. The holder 105 may be implemented using a variety of materials. For example, the holder 105 may be implemented using one or more of the following materials: aluminum, steel, stainless steel, polyvinyl chloride (PVC), or any other material sufficiently rigid to support the weight of a typical umbrella.

The holder 105 may have two distal ends 107A and 107B. The holder is typically configured to have a hollow interior, which may be substantially cylindrical to accept at end 107A the pole 185 of an umbrella. The exterior of the holder 105 may have a cylindrical shape, but other shapes may be used as well.

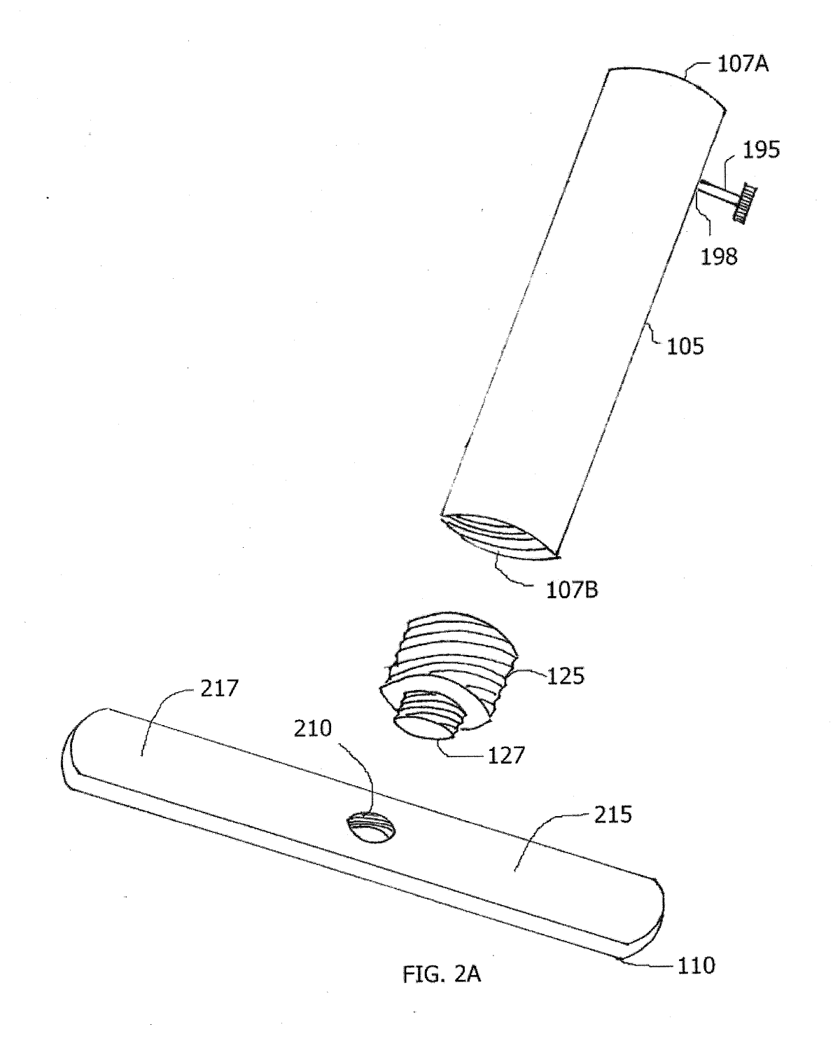

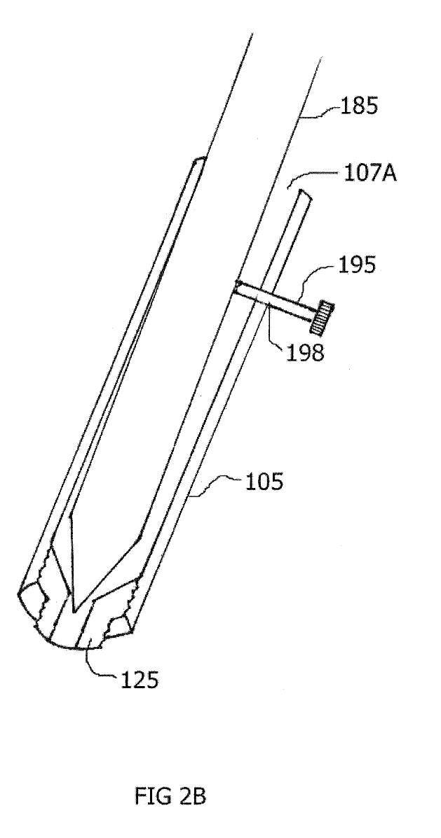

The first end 107A may have an opening, and the second end 107B may include an interior thread to allow coupler 125 to be attached to the holder 105. The depth of the interior thread at the second end 107B may be about 0.625 inches from the end 107B of the holder 105. In some implementations, the coupler 125 serves as the bottom 199, on which a pole 185 of an umbrella may rest. In other implementations, the coupler 125 is substantially hollowed at an angle to allow an end of the umbrella pole 185 (e.g., the tip of the pole 185 which is typically pointed), upon insertion into holder 105, to be guided into coupler 125 and thus rest within the hollowed opening of the coupler 125, as depicted at FIG. 2B. This hollow opening in the coupler 125 enables the umbrella pole 185 to fit more securely in the holder 105, when compared to approaches that do not use the hollowed coupler 125 or an opening at the bottom of the holder for the umbrella pole to secure into. Moreover, when a set screw 195 is used to secure the umbrella pole 185, the umbrella 180 and pole 185 are more securely locked in place.

In some implementations, the holder 105 is hollow and sized to allow the spikes 130 and 131 and platform 110 to be inserted into the top (i.e., the first end 107A) of holder 105, when the spikes are removed from the platform 110. This collapsible-spike configuration of the umbrella anchor 100 may provide enhanced portability, when compared to other umbrella anchors in which the spikes are fixed permanently to the anchoring device.

FIG. 2A depicts an example implementation of coupler 125. The coupler 125 is threaded to allow one end of the coupler 125 to be inserted into the interior threaded receptacle 107B of holder 105, and the distal end 127 of coupler 125 to be inserted into a threaded receptacle 210 of platform 110. Although FIG. 2A depicts coupler 125 as detachable from holder 105, in some implementations coupler 125 is fixedly attached within the holder 105, so that a user cannot remove the coupler 125 from the holder 105. As such, a user is only able to screw the coupler 125 (e.g., threaded portion 127) into the threaded receptacle 210 of platform 110. Although the coupler 125 is depicted as a threaded coupler, the coupler 125 may be implemented using other coupling mechanisms including a quick release mechanism, a pressure release mechanism, and the like.

The platform 110 may be implemented using a variety of materials. For example, the platform 110 may be implemented using one or more of the following materials: aluminum, steel, stainless steel, polyvinyl chloride (PVC), or any other material sufficiently rigid to support the weight of a typical umbrella. The platform 110 provides lateral support to prevent the umbrella anchor 100 from falling over when an umbrella pole 185 is inserted into holder 105. The platform 110 may be shaped like a rectangle with rounded ends to allow a user to press on the platform 110 when inserting the umbrella anchor 100 and spikes 130 and 131 into the ground, sand, and the like. For example, a user may press on portions 215 and 217 to facilitate insertion of umbrella anchor 100 and spikes 130 and 131 into the ground, sand, and the like.

Threaded receptacles 218 and 219 may be configured on platform 110. The threaded receptacles 218 and 219 are at distal ends of platform 110. The threaded receptacles 218 and 219 are each threaded to allow the threaded end of a spike to be coupled into threaded receptacles 218 and 219. In some implementations, the threaded receptacles 218 and 219 are placed within the centerline of platform 110; while in other implementations, the threaded receptacles are offset slightly from the centerline of the platform 110. The threaded receptacle 210 may be midway between the ends of platform 110 (i.e., about equidistant from threaded receptacle 218 and threaded receptacle 219).

In an alternative configuration, spikes 130 and 131 are fixedly coupled to the platform 110, but in this configuration, the spikes 130 and 131 are fixed to allow pivoting between two primary operative positions. The first position is an open position in which the spikes 130 and 131 are locked into place to allow insertion into the ground, sand, and the like, as depicted in FIG. 1A. The second position is a closed position in which the spikes 130 and 131 are folded by moving each of the spikes 130 and 131 ninety degrees so that the spikes 130 and 131 rest along the bottom surface of the platform 110.

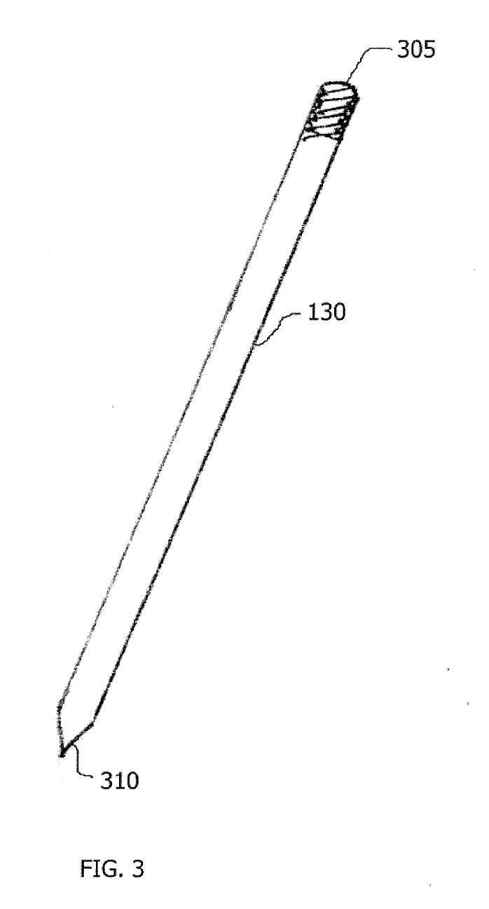

FIG. 3 depicts an example implementation of spike 130. Spike 131, although not shown, may be implemented in a manner similar to spike 130. The spike 130 may include a threaded end 305 and a shaped distal end 310 (e.g., a pointed end) to allow insertion into the ground, sand, or the like. The spikes 130 and 131 are sized to allow holder 105 to contain the spikes 130 and 131, when the spikes 130 and 131 are removed from the platform. Although FIG. 3 depicts spike 130 with a threaded end 305 for coupling into platform 110, spike 130 may use other coupling mechanisms as well, such as hinges, snap hinges, clips, collared thread, keyhole mounts, and the like. The spikes 130 and 131 are sized to have a length sufficient to provide stability to the umbrella anchor 100, when inserted into at least one of dirt, sand, or any other soil. The spikes 130 and 131 may be implemented using a variety of materials. For example, the spikes 130 and 131 may be implemented using one or more of the following materials: aluminum, steel, stainless steel, polyvinyl chloride (PVC), or any other material sufficiently rigid enough to penetrate the earth's surface (dirt, sand, grass or any other soil) and to support the umbrella anchor and a typical umbrella.

In some implementations, the holder 105 is sized to about 10.0 inches. The holder 105 has an inner diameter of 1.5 inches to allow insertion of a pole of an umbrella, as well as spikes 130 and 131 and, in some cases, platform 110. The platform 110 is sized to about 1.375 inches by 9.75 inches. The coupler 125 is sized to about 1.125 inches in height. The spikes each have a length of about 9.625 inches and a diameter of about 0.5 inches. The ratio of the length of the holder 105 to the length of the platform 110 is about 1.03 to 1. The ratio of the length of the platform 110 to the length of the spike is about 1.01 to 1. These ratios may, in some implementations, allow enhanced anchoring, while enabling the spikes and platform to be collapsed into the holder 105 for enhanced portability. These dimensions are for umbrella having a diameter of about 96 inches, although other sized components of umbrella anchor 100 may be used as well.

In some implementations, the umbrella anchor 100 is collapsible and portable. Specifically, the spikes 130 and 131 may be readily detached from the platform 110 by unscrewing the spikes 130 and 131 from the platform 110 and inserting the spikes 130 and 131 into holder 105. As noted, the platform 110 may be detached from holder 105 and also be inserted into holder 105 for portability.

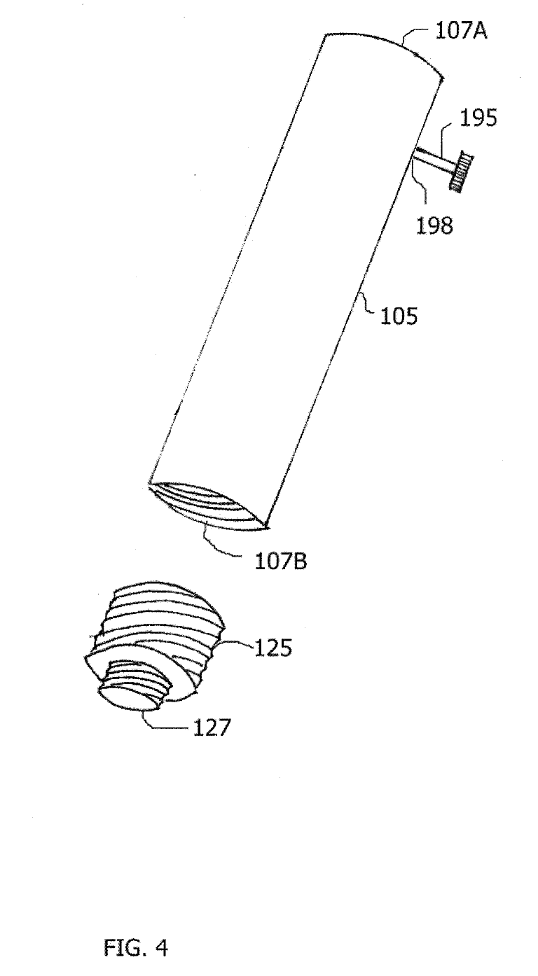

FIG. 4 depicts holder 105 when spikes 130 and 131 (and/or platform 110) have been inserted (i.e., after being detached from platform 110). The interior of holder 105 may be threaded at end 107B. The spikes 130 and 131 may be inserted into holder 105 via opening 107A (also referred to as a receptacle), when the umbrella pole 185 is removed from the holder 105. Moreover, opening 107A may be capped with, e.g., a plastic cap to captivate the spikes 130-131 and/or platform 110 contained within the holder 105. In some implementations, the two spikes 130 and 131 are removable, but the coupler 125 is fixedly attached to the bottom opening 107B of holder 105. In this configuration, a separate cap is used at the top opening 107A to secure the spikes 130 and 131 within to holder 105 to provide portability, when the umbrella is collapsed and the umbrella pole is removed from the holder 105.

As noted, the umbrella anchor 100 may be implemented to provide stability to an umbrella when anchored to the ground to prevent the umbrella from leaning, tilting, blowing away, or falling over and possibly causing injury. Moreover, the umbrella anchor 100 provides leverage, so that the umbrella anchor can be driven into any ground surface, such as sand, dirt or clay, by using a user's foot to apply pressure.

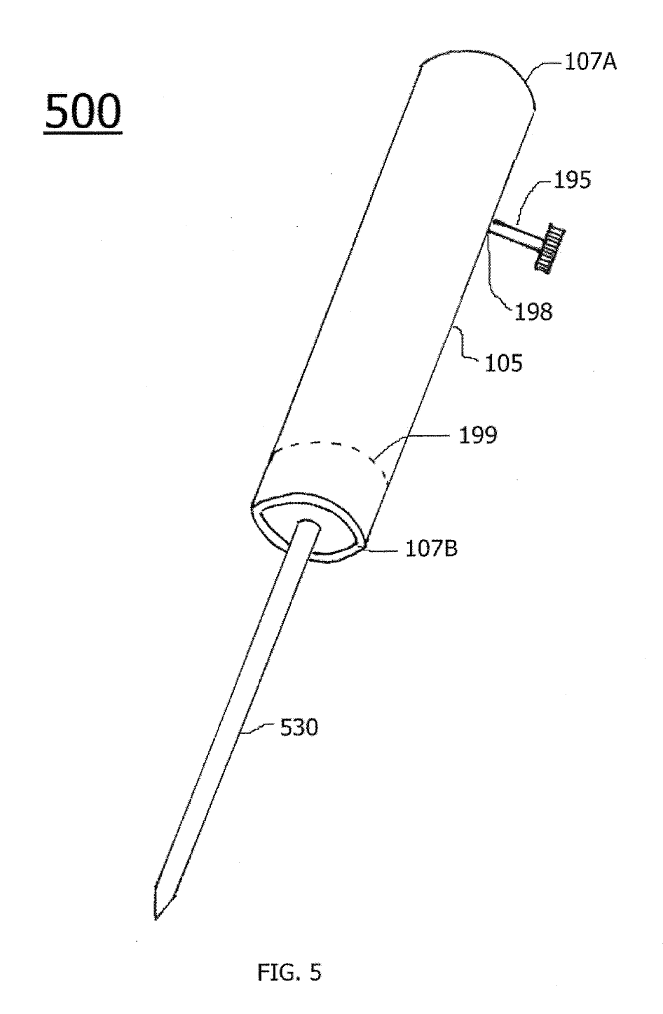

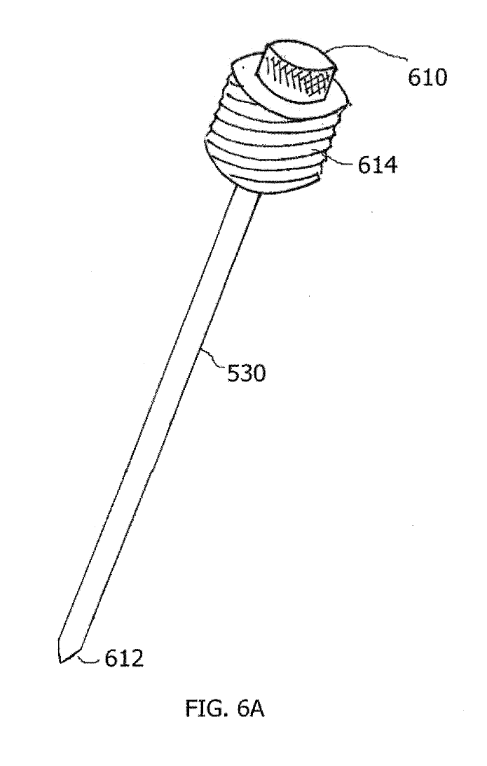

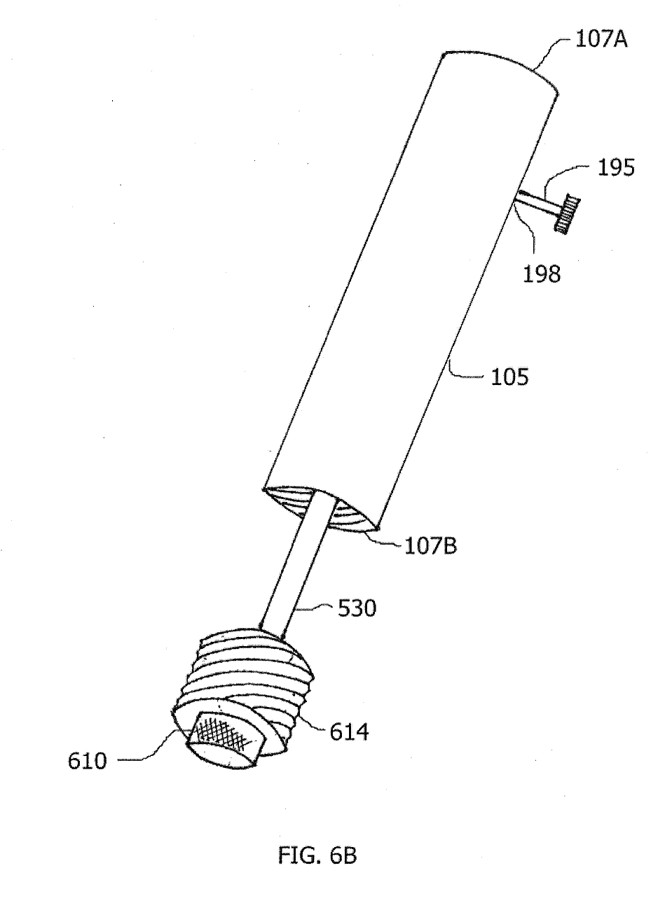

FIG. 5 depicts an umbrella anchor 500 including a set screw 195, a threaded receptacle 198 for the set screw 195, a holder 105, and an integrated coupler-spike 530. The holder 105 further includes a first end 107A and a second end 107B. The interior of holder 105 (i.e., second, bottom end 107B) may be threaded to enable the threaded portion 614 (described further below with respect to FIGS. 6A-6B) of integrated coupler-spike 530 to be inserted into the second, bottom end 107B.

FIG. 6A depicts integrated coupler-spike 530. The integrated coupler-spike 530 includes a threaded portion to allow insertion (e.g., screwed) into the bottom end 107B of holder 105. In this configuration, umbrella anchor 500 allows an umbrella pole to be inserted at the top end 107A of the holder 105, while the integrated coupler-spike 530 is inserted into the soil, sand, and the like to provide anchoring. To collapse the umbrella anchor 500, a user unscrews integrated coupler-spike 530 from end 107B, and inserts the pointed end 612 into holder 105. Next, the user screws the integrated coupler-spike 530 into the opening 107B. The integrated coupler-spike 530 may be knurled 610 to facilitate screwing integrated coupler-spike 530 into the opening 107B of holder 105. FIG. 6B depicts integrated coupler-spike 530 being inserted into holder 105 for portability.

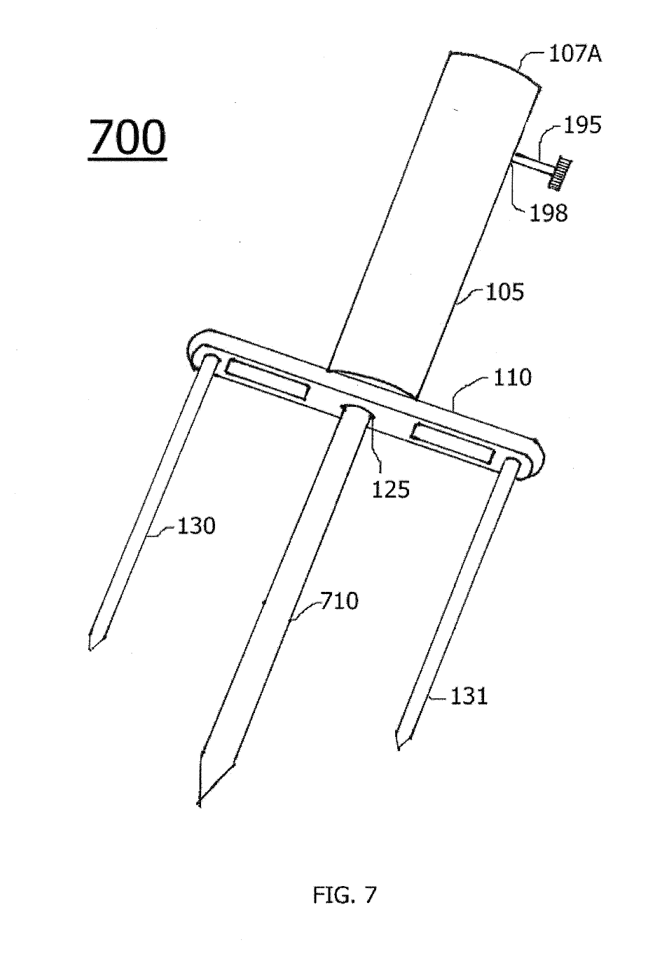

Although the above examples depict an umbrella anchor having one or two spikes, the umbrella anchor may have other quantities of spikes. For example, FIG. 7 depicts the umbrella anchor 700 including three spikes 130-131 and a center spike 710 configured through an opening in the bottom of coupler 125. In this configuration, The holder measures about 15 inches in length and an inner diameter of 1.75 inches to allow insertion of an umbrella pole. The center spike 710 may be the same length as spikes 130-131. However, the center spike 710 may be implemented to have a length of 14 inches, while the outer spikes 130-131 have a length of 12 inches. Also in this configuration of umbrella anchor 700, the platform will be sized to about 1.625 inches by 14.75 inches.

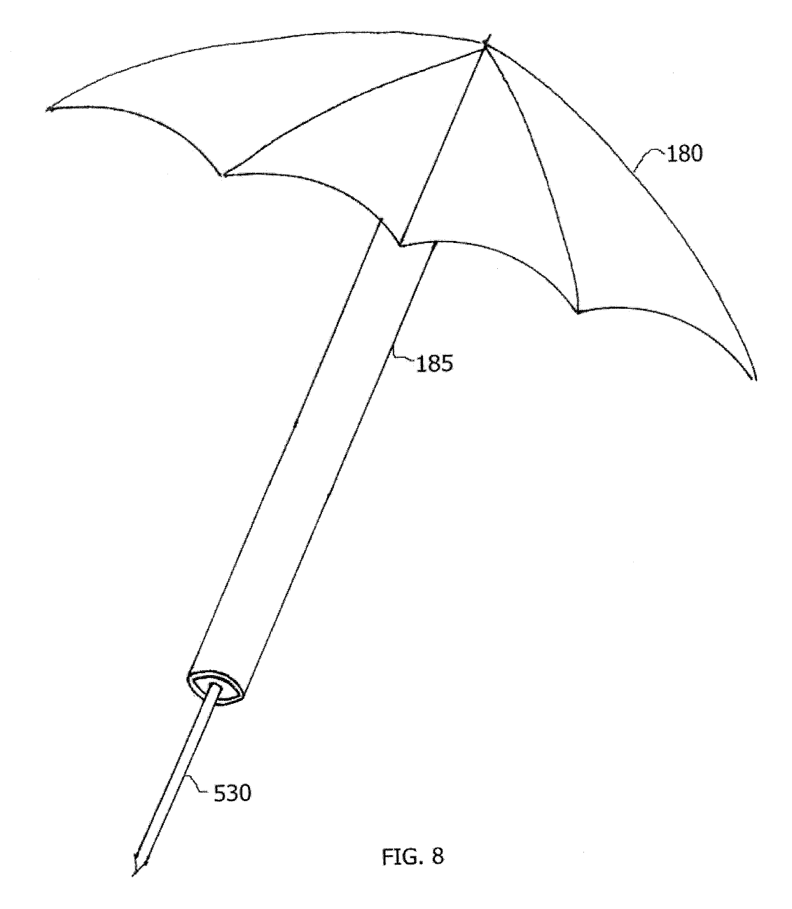

In some implementations, the coupler-spike 530 is integrated to the umbrella pole 185, as depicted at FIG. 8.

The foregoing description is intended to illustrate but not to limit the scope of the invention, which is defined by the scope of the appended claims. Other embodiments are within the scope of the following claims.

What is claimed:

1. A device comprising:
a holder comprising a hollow interior, a first end configured to receive an umbrella pole, a bottom configured to allow the umbrella pole to rest, and a second end;
a coupler;
a platform configured to support the device, the platform coupled to the holder using the coupler, the platform comprising a first receptacle and a second receptacle, the first and second receptacles at distal ends of the bottom of the platform;
a first spike configured to be detachably inserted into the first receptacle; and
a second spike configured to be detachably inserted into the second receptacle, wherein the first and second spikes may be detached from the first and second receptacles, the detached first and second spikes configured to be inserted in the first end of the holder, when the umbrella pole has been removed from the holder, the first end of the holder configured to accept a cap to secure the first and second spikes contained with the holder.

2. The device of claim 1, wherein a first end of the coupler is threaded to allow insertion into a first threaded receptacle of the platform, the first threaded receptacle located along the centerline of the platform and about equidistant from the first and second receptacles of the platform.

3. The device of claim 1, wherein a first end of the coupler is threaded to allow insertion into a first threaded receptacle of the platform, and a second end of the coupler is threaded to allow insertion into another threaded receptacle of the holder.

4. The device of claim 1, wherein the platform may configured to be contained within the interior of the holder.

5. The device of claim 1, wherein the coupler is the cap.

6. A device comprising:
a holder comprising a hollow interior, a first end configured to receive an umbrella pole and a second end; and
a coupler configured with a spike to form a coupler-spike, the coupler-spike detachably inserted into the second end of the holder to provide support for the device, the coupler-spike configured to be detachably inserted into the second end of the holder, such that the holder contains the spike portion of the coupler-spike.
